(19) United States
(12) Patent Application Publication
(10) Pub. No.: US 2020/0180144 A1
(43) Pub. Date: Jun. 11, 2020

(54) MEASURING APPARATUS AND SUBSTRATE MEASURING METHOD

(71) Applicant: Wuhan China Star Optoelectronics TechnologyCo., Ltd., Wuhan (CN)

(72) Inventors: Hao LI, Wuhan (CN); Guohui Pan, Wuhan (CN); Bin Wang, Wuhan (CN)

(73) Assignee: Wuhan China Star Optoelectronics Technology Co., Ltd., Wuhan (CN)

(21) Appl. No.: 16/467,983

(22) PCT Filed: Mar. 11, 2019
(86) PCT No.: PCT/CN2019/077650

§ 371 Date: Jun. 10, 2019

(30) Foreign Application Priority Data
Mar. 27, 2018 (CN) 201810259642.1

(51) Int. Cl. B25J 9/06; G02F 1/13

(52) U.S. Cl. CPC B25J 9/06; G02F 1/1339; G02F 1/1303

(57) ABSTRACT

The present application provides a measuring apparatus and a substrate measuring method. The measuring apparatus includes a measuring mechanism that performs the measurement, a robotic arm that takes out and transfers the substrate, and a rotating mechanism that adjusts the direction of the substrate. The present application uses the mutual cooperation between the rotating mechanism, the robotic arm and the measuring mechanism by adding the rotating mechanism to the measuring apparatus and improving the robotic arm and the measuring mechanism to measure and tape out different types of substrates.

### FIELD OF INVENTION

The present application generally relates to the display technology and, more particularly, to a measuring apparatus and a substrate measuring method.

### BACKGROUND OF INVENTION

In the manufacturing process of a liquid-crystal cell, the frame sealant serves as a medium binding an array substrate and a color filter to form a liquid-crystal cell. However, the frame sealant may easily overflow to the peripheral circuit area of an adjacent array substrate during coating, which causes the contamination of a liquid-crystal panel.

In order to overcome the contamination of the peripheral circuit area caused by the frame sealant, a back-to-back layout design of array substrates can be used. On the basis of the conventional side-by-side design, the array substrate adjacent to the short side of an array substrate is rotated by 180° to overcome the contamination in the wiring area of a peripheral drive circuit caused by the frame sealant.

In the manufacturing process of a liquid-crystal panel, it is necessary to measure the functions of each component on the substrate, which needs to be performed on a measuring apparatus, for example, an electrical yielding measuring apparatus for the array substrate. Owing to the mechanism design of some measuring apparatuses, the substrate should be placed on a measuring apparatus to meet the directional and positional requirements when being measured.

However, the current measuring apparatuses are mainly used for measuring side-by-side substrates without considering the special layout of back-to-back substrates.

Therefore, there is a need to provide a measuring apparatus and a substrate measuring method capable of measuring side-by-side substrates and back-to-back substrates.

### SUMMARY OF INVENTION

The present application provides a measuring apparatus and a substrate measuring method to overcome the problem that the conventional measuring apparatus critical with the position and the direction of the substrate to be measured is unable to measure and tape out the back-to-back substrate.

To achieve the foregoing object, the technical solution in the present application provides the following.

According to one aspect of the present application, a measuring apparatus for automatically measuring a substrate is provided, which includes a measuring mechanism, a robotic arm, and a rotating mechanism,

the measuring mechanism being configured to measure the substrate and including a measuring platform for placing the substrate, a measuring unit for measuring the substrate, and a first clamping plate;

the measuring platform being divided into a first measurement area and a second measurement area, the first measurement area being a vertical substrate area, and the second measurement area being a horizontal substrate area;

the robotic arm being configured to take out and transfer the substrate, the robotic arm including a first robotic arm and a second robotic arm; and

the rotating mechanism being disposed above the measuring mechanism and configured to rotate the substrate to a desired angle, the rotating mechanism including a rotating unit for rotating the substrate, a fixing unit for fixing the substrate, a supporting unit, and a control unit for accepting an instruction,

wherein, an array substrate is arranged on the substrate, the array substrate includes a display area and a peripheral circuit area, the display area is disposed corresponding to a direction of a console, and the peripheral circuit area is disposed corresponding to a direction of the robotic arm.

According to one embodiment of the present application, the robotic arm includes prongs, and the number of prongs of the second robotic arm is larger than the number of prongs of the first robotic arm; and

the substrate is operated by the first robotic arm when a long side of the substrate faces the robotic arm, and the substrate is operated by the second robotic arm when a short side of the substrate faces the robotic arm.

According to one embodiment of the present application, the substrate includes a horizontal back-to-back substrate, a vertical back-to-back substrate, a horizontal non-back-to-back substrate, and a vertical non-back-to-back substrate.

According to one embodiment of the present application, the rotating unit includes a rotating electrical machine, the fixing unit includes a second clamping plate for fixing four sides of the substrate and a vacuum sucker for sucking the substrate, the control unit includes a programmable logic controller (PLC) control unit, and the supporting unit includes a frame of the rotating mechanism.

According to another aspect of the present application, a substrate measuring method is provided, which uses the measuring apparatus to measure the substrate, the substrate measuring method including the following steps.

In Step S10, a computer-integrated manufacturing (CIM) system generates the instruction according to the type of the substrate and transmits the instruction to the measuring mechanism, the robotic arm, and the rotating mechanism.

In Step S20, the robotic arm takes out the substrate from the storage device and places the substrate at the rotating mechanism after receiving the instruction, and the robotic arm transfers the substrate to the measuring mechanism after the rotating mechanism rotates the substrate to a target angle, so as to complete measuring the substrate through the mutual cooperation between the robotic arm, the rotating mechanism, and the measuring mechanism.

In Step S30, the robotic arm places the substrate in a designated area of the storage device.

According to one embodiment of the present application, when the substrate is a vertical non-back-to-back substrate, Step S20 includes:

after receiving the instruction, directly taking out the substrate from the storage device and placing the substrate at the rotating mechanism to rotate by 0° or 180°, transferring the substrate to the first measurement area to measure the substrate, and then restoring the substrate to an original angle by the rotating mechanism to complete measuring the substrate.

According to one embodiment of the present application, when the substrate is a horizontal non-back-to-back substrate, Step S20 includes:

after receiving the instruction, taking out the substrate from the storage device and placing the substrate at the rotating mechanism to rotate by 90° or 270°, transferring the substrate to the second measurement area to measure the substrate, and then restoring the substrate to an original angle by the rotating mechanism to complete measuring the substrate.

According to one embodiment of the present application, when the substrate is a back-to-back substrate, the back-to-back substrate includes a first array substrate and a second array substrate, the direction of the first array substrate is the same as the direction of the array substrate required by the measuring platform.

According to one embodiment of the present application, when the substrate is a vertical back-to-back substrate, Step S20 includes:

after receiving the instruction, taking out the substrate from the storage device and directly transferring the substrate to the first measurement area to measure the first array substrate, placing the substrate at the rotating mechanism to rotate by 180° and transferring the substrate to the first measurement area to measure the second array substrate, and then restoring the substrate to an original angle by the rotating mechanism to complete measuring the substrate.

According to one embodiment of the present application, when the substrate is a horizontal back-to-back substrate, Step S20 includes:

after receiving the instruction, taking out the substrate from the storage device and transferring the substrate to the rotating mechanism to rotate by 90°, transferring the substrate to the second measurement area to measure the first array substrate, transferring the substrate to the rotating mechanism to rotate by 180°, which indicates that the substrate has been rotated by 270° with respect to an initial position thereof, then transferring the substrate to the second measurement area, and restoring the substrate to an original angle by the rotating mechanism to complete measuring the substrate.

According to still another aspect of the present application, a substrate measuring method is further provided, which uses the measuring apparatus to measure the substrate, including:

In Step S10, a computer-integrated manufacturing (CIM) system generates the instruction according to the type of the substrate and transmits the instruction to the measuring mechanism, the robotic arm, and the rotating mechanism.

In Step S20, the robotic arm takes out the substrate from the storage device and places the substrate at the rotating mechanism after receiving the instruction, and the robotic arm transfers the substrate to the measuring mechanism after the rotating mechanism rotates the substrate to a target angle, so as to complete measuring the substrate through the mutual cooperation between the robotic arm, the rotating mechanism, and the measuring mechanism.

In Step S30, the robotic arm places the substrate in a designated area of the storage device.

The substrate is a glass substrate.

According to one embodiment of the present application, when the substrate is a vertical non-back-to-back substrate, Step S20 includes:

after receiving the instruction, directly taking out the substrate from the storage device and placing the substrate at the rotating mechanism to rotate by 0° or 180°, transferring the substrate to the first measurement area to measure the substrate, and then restoring the substrate to an original angle by the rotating mechanism to complete measuring the substrate.

According to one embodiment of the present application, when the substrate is a horizontal non-back-to-back substrate, Step S20 includes:

after receiving the instruction, taking out the substrate from the storage device and placing the substrate at the rotating mechanism to rotate by 90° or 270°, transferring the substrate to the second measurement area to measure the substrate, and then restoring the substrate to an original angle by the rotating mechanism to complete measuring the substrate.

According to one embodiment of the present application, when the substrate is a back-to-back substrate, the back-to-back substrate includes a first array substrate and a second array substrate, the direction of the first array substrate is the same as the direction of the array substrate required by the measuring platform, and the direction of the second array substrate is opposite to the direction of the array substrate required by the measuring platform.

According to one embodiment of the present application, when the substrate is a vertical back-to-back substrate, Step S20 includes:

after receiving the instruction, taking out the substrate from the storage device and directly transferring the substrate to the first measurement area to measure the first array substrate, placing the substrate at the rotating mechanism to rotate by 180° and transferring the substrate to the first measurement area to measure the second array substrate, and then restoring the substrate to an original angle by the rotating mechanism to complete measuring the substrate.

According to one embodiment of the present application, when the substrate is a horizontal back-to-back substrate, Step S20 includes:

after receiving the instruction, taking out the substrate from the storage device and transferring the substrate to the rotating mechanism to rotate by 90°, transferring the substrate to the second measurement area to measure the first array substrate, transferring the substrate to the rotating mechanism to rotate by 180°, which indicates that the substrate has been rotated by 270° with respect to an initial position thereof, then transferring the substrate to the second measurement area, and restoring the substrate to an original angle by the rotating mechanism to complete measuring the substrate.

According to one embodiment of the present application, the robotic arm includes prongs, and the number of prongs of the second robotic arm is larger than the number of prongs of the first robotic arm; and

the substrate is operated by the first robotic arm when a long side of the substrate faces the robotic arm, and the substrate is operated by the 10 second robotic arm when a short side of the substrate faces the robotic arm.

According to one embodiment of the present application, the substrate includes a horizontal back-to-back substrate, a vertical back-to-back substrate, a horizontal non-back-to-back substrate, and a vertical non-back-to-back substrate.

According to one embodiment of the present application, the rotating unit includes a rotating electrical machine, the fixing unit includes a second clamping plate for fixing four sides of the substrate and a vacuum sucker for sucking the substrate, the control unit includes a programmable logic controller (PLC) control unit, and the supporting unit includes a frame of the rotating mechanism.

The beneficial effect: the present application uses the mutual cooperation between the rotating mechanism, the robotic arm and the measuring mechanism by adding the rotating mechanism to the measuring apparatus and improving the robotic arm and the measuring mechanism to measure and tape out different types of substrates.

### DESCRIPTION OF DRAWINGS

In order to more clearly illustrate the technical solutions in the embodiments or the prior art, the drawings used in the embodiments or the prior art description will be briefly described below. Obviously, the drawings in the following description are only some implementations of the present application. For example, other drawings may be obtained, without creative efforts, by those of ordinary skill in the art in light of the inventive work.

FIG. 1 is a schematic structural view of a vertical back-to-back substrate;

FIG. 2 is a schematic structural view of a rotating mechanism according to one embodiment of the present application;

FIG. 3 is a schematic structural view of a first robotic arm according to one embodiment of the present application;

FIG. 4 is a schematic structural view of a second robotic arm according to one embodiment of the present application;

FIG. 5 is an overall schematic structural view of a robotic arm according to one embodiment of the present application;

FIG. 6 is a schematic structural view of a measuring mechanism according to one embodiment of the present application;

FIG. 7 is a flowchart of a substrate measuring method according to one embodiment of the present application; and

FIG. 8 are schematic diagrams showing a back-to-back substrate in a measuring process with respect to different rotation angles according to one embodiment of the present application.

### DETAILED DESCRIPTION OF PREFERRED EMBODIMENTS

The following description of each embodiment is referred to accompanying drawings to illustrate specific embodiments of the present application that can be implemented. The directional terms mentioned in the present application, such as “up”, “below”, “front”, “after”, “left”, “right”, “in”, “out”, “side”, etc., only refer to the orientations in the accompanying drawings. Therefore, the directional terms used are to explain and understand the present application, instead of limiting the present application. In the drawings, structurally similar units are denoted by the same numerals.

The present application provides a measuring apparatus and a substrate measuring method to overcome the problem that the conventional measuring apparatus critical with the position and the direction of the substrate to be measured is unable to measure and tape out the back-to-back substrate.

The present application is further described below with reference to the accompanying drawings and specific embodiments:

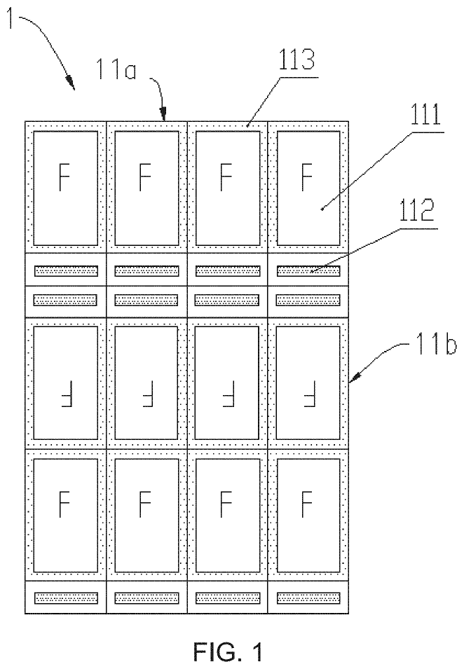

Referring to FIG. 1, FIG. 1 is a schematic structural view of a vertical back-to-back substrate.

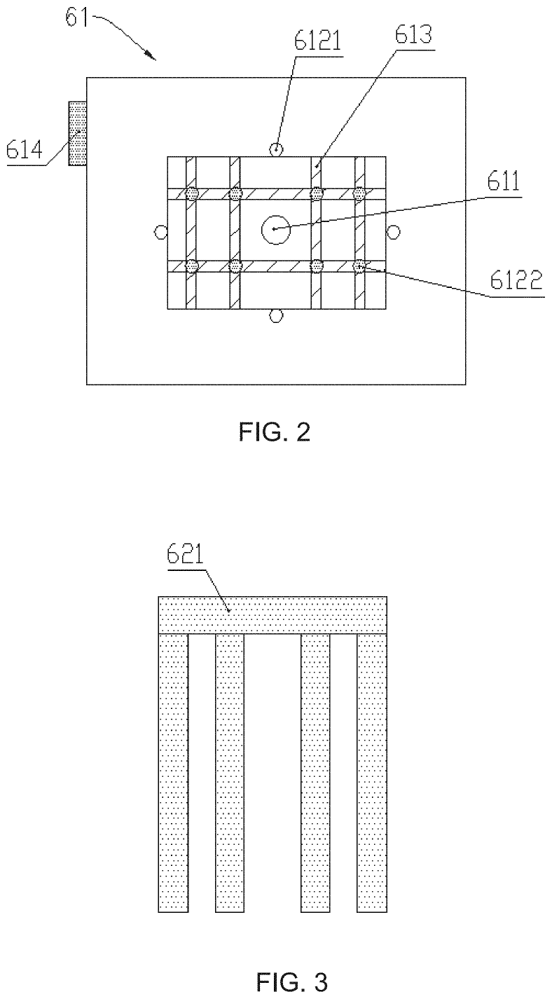

Referring to FIG. 2, FIG. 2 is a schematic structural view of a rotating mechanism according to one embodiment of the present application.

Referring to FIG. 3, FIG. 3 is a schematic structural view of a first robotic arm according to one embodiment of the present application.

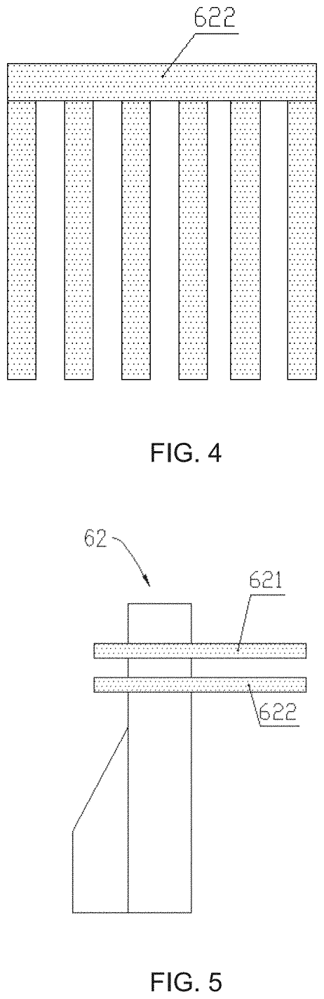

Referring to FIG. 4, FIG. 4 is a schematic structural view of a second robotic arm according to one embodiment of the present application.

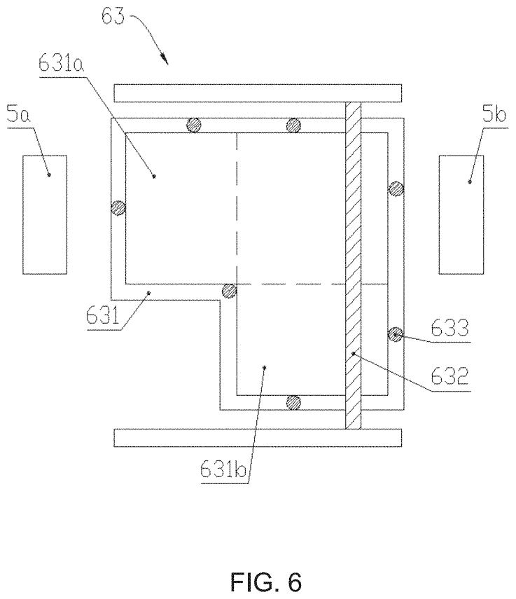

Referring to FIG. 6, FIG. 6 is a schematic structural view of a measuring mechanism according to one embodiment of the present application.

The present application provides a measuring apparatus for automatically measuring a substrate, which includes a measuring mechanism 63, a robotic arm 62, and a rotating mechanism 61.

The measuring mechanism 63 is configured to measure the substrate and includes a measuring platform 631 for placing the substrate, a measuring unit 632 for measuring the substrate, and a first clamping plate 633.

The measuring platform 631 is divided into a first measurement area 631a and a second measurement area 631b. The first measurement area 631a is a vertical substrate area, and the second measurement area is a horizontal substrate area.

The robotic arm 62 is configured to take out and transfer the substrate, and the robotic arm 62 includes a first robotic arm 621 and a second robotic arm 622.

The rotating mechanism 61 is disposed above the measuring mechanism 63 and configured to rotate the substrate to a desired angle. The rotating mechanism 61 includes a rotating unit 611 for rotating the substrate, a fixing unit 612 for fixing the substrate, a supporting unit 613, and a control unit 614 for accepting an instruction.

An array substrate 11 is arranged on the substrate. The array substrate 11 includes a display area 111 and a peripheral circuit area 112. When the substrate 11 is under measurement, the display area 111 is disposed corresponding to a direction 5b of a console, and the peripheral circuit area 112 is disposed corresponding to a direction 5a of the robotic arm.

Referring to FIG. 5, FIG. 5 is an overall schematic structural view of a robotic arm according to one embodiment of the present application.

The robotic arm 62 includes prongs, and the number of prongs of the second robotic arm 622 is larger than the number of prongs of the first robotic arm 621.

The substrate is operated by the first robotic arm 621 when a long side of the substrate faces the robotic arm 62, and the substrate is operated by the second robotic arm 622 when a short side of the substrate faces the robotic arm 62. Such arrangement is advantageous in that the stability of the robotic arm during capturing and transferring can be improved by taking out the substrate by the second robotic arm 622 having a larger number of prongs so that the substrate is effectively prevented from slipping with respect to the characteristic that the substrate is rotating during the measuring process.

More particularly, the substrate includes a horizontal back-to-back substrate, a vertical back-to-back substrate, a horizontal non-back-to-back substrate, and a vertical non-back-to-back substrate. In the present application, the control mechanism can output corresponding instructions by identifying different substrates to further measure and tape out different substrates.

In one embodiment, the rotating unit 611 includes a rotating electrical machine, the fixing unit 612 includes a second clamping plate 6121 for fixing four sides of the substrate and a vacuum sucker 6122 for sucking the substrate, the control unit 614 includes a programmable logic controller (PLC) control unit, and the supporting unit 613 includes a frame of the rotating mechanism 61.

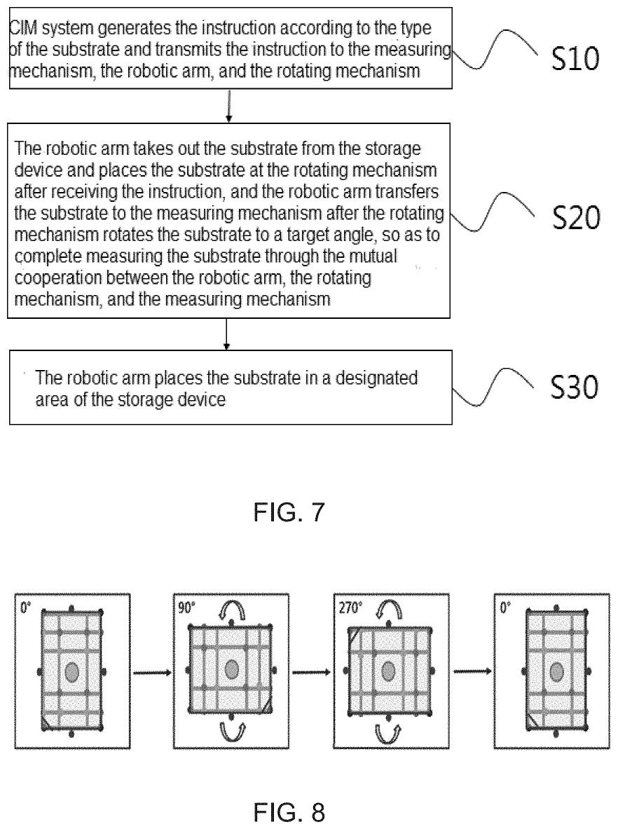

As shown in FIG. 7, according to another aspect of the present application, a substrate measuring method is further provided, which uses the measuring apparatus of claims 1 to 4 to measure the substrate, the substrate measuring method including the following steps.

In Step S10, a computer-integrated manufacturing (CIM) system generates the instruction according to the type of the substrate and transmits the instruction to the measuring mechanism, the robotic arm, and the rotating mechanism.

In Step S20, the robotic arm 62 takes out the substrate from the storage device and places the substrate at the rotating mechanism 61 after receiving the instruction, and the robotic arm 62 transfers the substrate to the measuring mechanism 61 after the rotating mechanism 61 rotates the substrate to a target angle, so as to complete measuring the substrate through the mutual cooperation between the robotic arm 62, the rotating mechanism 61, and the measuring mechanism 63.

In Step S30, the robotic arm 62 places the substrate in a designated area of the storage device.

Among them, the CIM system is a computer-integrated manufacturing system for collectively controlling the actual operation of each apparatus during the manufacturing and measurement of the substrate through the instruction.

Specifically, in Embodiment 2, when the substrate is a vertical non-back-to-back substrate, the specific operation of Step S20 includes:

after receiving the instruction, directly taking out the substrate from the storage device and placing the substrate at the rotating mechanism 61 to rotate by 0° or 180°, transferring the substrate to the first measurement area 631a to measure the substrate, and then restoring the substrate to an original angle by the rotating mechanism 61 to complete measuring the substrate. The step involving taking out and transferring the substrate is implemented by the robotic arm 62.

In Embodiment 3, when the substrate is a horizontal non-back-to-back substrate, the operation of Step S20 includes:

after receiving the instruction, taking out the substrate from the storage device and placing the substrate at the rotating mechanism to rotate by 90° or 270°, transferring the substrate to the second measurement area 631b to measure the substrate, and then restoring the substrate to an original angle by the rotating mechanism rotating mechanism 61 to complete measuring the substrate. The step involving taking out and transferring the substrate is implemented by the robotic arm 62.

When the substrate is a back-to-back substrate, the back-to-back substrate includes a first array substrate 11a and a second array substrate 11b, the direction of the first array substrate 11a is the same as the direction of the array substrate required by the measuring platform, and the direction of the second array substrate 11b is opposite to the direction of the array substrate required by the measuring platform.

In Embodiment 4, when the substrate is a vertical back-to-back substrate, the specific operation of Step S20 includes:

after receiving the instruction, taking out the substrate from the storage device and directly transferring the substrate to the first measurement area 631a to measure the first array substrate 11a, placing the substrate at the rotating mechanism 61 to rotate by 180° and transferring the substrate to the first measurement area 631a to measure the second array substrate 11b, and then restoring the substrate to an original angle by the rotating mechanism 61 to complete measuring the substrate. The step involving taking out and transferring the substrate is implemented by the robotic arm 62.

In Embodiment 5, when the substrate is a horizontal back-to-back substrate, the specific operation of Step S20 includes:

after receiving the instruction, taking out the substrate from the storage device and transferring the substrate to the rotating mechanism 61 to rotate by 90°, transferring the substrate to the second measurement area 631b to measure the first array substrate 11a, transferring the substrate to the rotating mechanism 61 to rotate by 180°, which indicates that the substrate has been rotated by 270° with respect to an initial position thereof, then transferring the substrate to the second measurement area 631b, and restoring the substrate to an original angle by the rotating mechanism 61 to complete measuring the substrate. The step involving taking out and transferring the substrate is implemented by the robotic arm 62.

Furthermore, the rotation angle of the back-to-back substrate in Embodiment 5 is measured as shown in FIG. 1.

The operation principle of the substrate measuring method in the present application is the same as that of the measuring apparatus. For details, please refer to the operation principle of the measuring apparatus, and no further details are redundantly provided here.

The present application provides a measuring apparatus and a substrate measuring method, using the mutual cooperation between the rotating mechanism, the robotic arm and the measuring mechanism by adding the rotating mechanism to the measuring apparatus and improving the robotic arm and the measuring mechanism to measure and tape out different types of substrates.

In summary, although the present application has been disclosed in the above preferred embodiments, the preferred embodiments are not intended to limit the present application. Various modifications may be made by those with ordinary skill in the art without departing from the spirit and scope of the present application. The scope of the present application is defined by the appended claims.

What is claimed is:

1. A measuring apparatus for automatically measuring a substrate, comprising a measuring mechanism, a robotic arm, and a rotating mechanism,
the measuring mechanism being configured to measure the substrate and comprising a measuring platform for placing the substrate, a measuring unit for measuring the substrate, and a first clamping plate;
the measuring platform being divided into a first measurement area and a second measurement area, the first measurement area being a vertical substrate area, and the second measurement area being a horizontal substrate area;
the robotic arm being configured to take out and transfer the substrate, the robotic arm comprising a first robotic arm and a second robotic arm; and
the rotating mechanism being disposed above the measuring mechanism and configured to rotate the substrate to a desired angle, the rotating mechanism comprising a rotating unit for rotating the substrate, a fixing unit for fixing the substrate, a supporting unit, and a control unit for accepting an instruction,
wherein, an array substrate is arranged on the substrate, the array substrate comprises a display area and a peripheral circuit area, the display area is disposed corresponding to a direction of a console, and the peripheral circuit area is disposed corresponding to a direction of the robotic arm.

2. The measuring apparatus according to claim 1, wherein:
the robotic arm comprises prongs, and the number of prongs of the second robotic arm is larger than the number of prongs of the first robotic arm; and
the substrate is operated by the first robotic arm when a long side of the substrate faces the robotic arm, and the substrate is operated by the second robotic arm when a short side of the substrate faces the robotic arm.

3. The measuring apparatus according to claim 1, wherein the substrate comprises a horizontal back-to-back substrate, a vertical back-to-back substrate, a horizontal non-back-to-back substrate, and a vertical non-back-to-back substrate.

4. The measuring apparatus according to claim 1, wherein the rotating unit comprises a rotating electrical machine, the fixing unit comprises a second clamping plate for fixing four sides of the substrate and a vacuum sucker for sucking the substrate, the control unit comprises a programmable logic controller (PLC) control unit, and the supporting unit comprises a frame of the rotating mechanism.

5. A substrate measuring method using the measuring apparatus according to claim 1 to measure the substrate, comprising:
Step S10, generating, by a computer-integrated manufacturing (CIM) system, the instruction according to the type of the substrate and transmitting the instruction to the measuring mechanism, the robotic arm, and the rotating mechanism;
Step S20, taking out, by the robotic arm, the substrate from the storage device and placing the substrate at the rotating mechanism after receiving the instruction, and transferring, by the robotic arm, the substrate to the measuring mechanism after the rotating mechanism rotates the substrate to a target angle, so as to complete measuring the substrate through the mutual cooperation between the robotic arm, the rotating mechanism, and the measuring mechanism; and
Step S30, placing, by the robotic arm, the substrate in a designated area of the storage device.

6. The substrate measuring method according to claim 5, wherein, when the substrate is a vertical non-back-to-back substrate, Step S20 comprises:
after receiving the instruction, directly taking out the substrate from the storage device and placing the substrate at the rotating mechanism to rotate by 0° or 180°, transferring the substrate to the first measurement area to measure the substrate, and then restoring the substrate to an original angle by the rotating mechanism to complete measuring the substrate.

7. The substrate measuring method according to claim 5, wherein, when the substrate is a horizontal non-back-to-back substrate, Step S20 comprises:
after receiving the instruction, taking out the substrate from the storage device and placing the substrate at the rotating mechanism to rotate by 90° or 270°, transferring the substrate to the second measurement area to measure the substrate, and then restoring the substrate to an original angle by the rotating mechanism to complete measuring the substrate.

8. The substrate measuring method according to claim 5, wherein, when the substrate is a back-to-back substrate, the back-to-back substrate comprises a first array substrate and a second array substrate, the direction of the first array substrate is the same as the direction of the array substrate required by the measuring platform, and the direction of the second array substrate is opposite to the direction of the array substrate required by the measuring platform.

9. The substrate measuring method according to claim 8, wherein, when the substrate is a vertical back-to-back substrate, Step S20 comprises:
after receiving the instruction, taking out the substrate from the storage device and directly transferring the substrate to the first measurement area to measure the first array substrate, placing the substrate at the rotating mechanism to rotate by 180° and transferring the substrate to the first measurement area to measure the second array substrate, and then restoring the substrate to an original angle by the rotating mechanism to complete measuring the substrate.

10. The substrate measuring method according to claim 8, wherein, when the substrate is a horizontal back-to-back substrate, Step S20 comprises:
after receiving the instruction, taking out the substrate from the storage device and transferring the substrate to the rotating mechanism to rotate by 90°, transferring the substrate to the second measurement area to measure the first array substrate, transferring the substrate to the rotating mechanism to rotate by 180°, which indicates that the substrate has been rotated by 270° with respect to an initial position thereof, then transferring the substrate to the second measurement area, and restoring the substrate to an original angle by the rotating mechanism to complete measuring the substrate.

11. A substrate measuring method using the measuring apparatus according to claim 1 to measure the substrate, comprising:
Step S10, generating, by a computer-integrated manufacturing (CIM) system, the instruction according to the type of the substrate and transmitting the instruction to the measuring mechanism, the robotic arm, and the rotating mechanism;
Step S20, taking out, by the robotic arm, the substrate from the storage device and placing the substrate at the rotating mechanism after receiving the instruction, and transferring, by the robotic arm, the substrate to the measuring mechanism after the rotating mechanism rotates the substrate to a target angle, so as to complete measuring the substrate through the mutual cooperation between the robotic arm, the rotating mechanism, and the measuring mechanism; and
Step S30, placing, by the robotic arm, the substrate in a designated area of the storage device
wherein the substrate is a glass substrate.

12. The substrate measuring method according to claim 11, wherein, when the substrate is a vertical non-back-to-back substrate, Step S20 comprises:
after receiving the instruction, directly taking out the substrate from the storage device and placing the substrate at the rotating mechanism to rotate by 0° or 180°, transferring the substrate to the first measurement area to measure the substrate, and then restoring the substrate to an original angle by the rotating mechanism to complete measuring the substrate.

13. The substrate measuring method according to claim 11, wherein, when the substrate is a horizontal non-back-to-back substrate, Step S20 comprises:
after receiving the instruction, taking out the substrate from the storage device and placing the substrate at the rotating mechanism to rotate by 90° or 270°, transferring the substrate to the second measurement area to measure the substrate, and then restoring the substrate to an original angle by the rotating mechanism to complete measuring the substrate.

14. The substrate measuring method according to claim 11, wherein, when the substrate is a back-to-back substrate, the back-to-back substrate comprises a first array substrate and a second array substrate, the direction of the first array substrate is the same as the direction of the array substrate required by the measuring platform, and the direction of the second array substrate is opposite to the direction of the array substrate required by the measuring platform.

15. The substrate measuring method according to claim 14, wherein, when the substrate is a vertical back-to-back substrate, Step S20 comprises:
after receiving the instruction, taking out the substrate from the storage device and directly transferring the substrate to the first measurement area to measure the first array substrate, placing the substrate at the rotating mechanism to rotate by 180° and transferring the substrate to the first measurement area to measure the second array substrate, and then restoring the substrate to an original angle by the rotating mechanism to complete measuring the substrate.

16. The substrate measuring method according to claim 14, wherein, when the substrate is a horizontal back-to-back substrate, Step S20 comprises:
after receiving the instruction, taking out the substrate from the storage device and transferring the substrate to the rotating mechanism to rotate by 90°, transferring the substrate to the second measurement area to measure the first array substrate, transferring the substrate to the rotating mechanism to rotate by 180°, which indicates that the substrate has been rotated by 270° with respect to an initial position thereof, then transferring the substrate to the second measurement area, and restoring the substrate to an original angle by the rotating mechanism to complete measuring the substrate.

17. The substrate measuring method according to claim 11, wherein:
the robotic arm comprises prongs, and the number of prongs of the second robotic arm is larger than the number of prongs of the first robotic arm; and
the substrate is operated by the first robotic arm when a long side of the substrate faces the robotic arm, and the substrate is operated by the second robotic arm when a short side of the substrate faces the robotic arm.

18. The substrate measuring method according to claim 11, wherein the substrate comprises a horizontal back-to-back substrate, a vertical back-to-back substrate, a horizontal non-back-to-back substrate, and a vertical non-back-to-back substrate.

19. The substrate measuring method according to claim 11, wherein the rotating unit comprises a rotating electrical machine, the fixing unit comprises a second clamping plate for fixing four sides of the substrate and a vacuum sucker for sucking the substrate, the control unit comprises a programmable logic controller (PLC) control unit, and the supporting unit comprises a frame of the rotating mechanism.
